(19) United States
(12) Patent Application Publication
(10) Pub. No.: US 2025/0296880 A1
(43) Pub. Date: Sep. 25, 2025

(54) FIRE RESISTANT COMPOSITE REBAR FOR CONCRETE STRUCTURES

(71) Applicant: Saudi Arabian Oil Company, Dhahran (SA)

(72) Inventors: Mahmoud Ali Dweib, Dhahran (SA); Mohammad Yousef Salloum, Dammam (SA); Emad Aisheh

(21) Appl. No.: 18/614,987

(22) Filed: Mar. 25, 2024

(51) Int. Cl. C04B 14/42; C04B 7/02; C04B 7/147; C04B 14/06; C04B 14/30; C04B 20/00; C04B 22/00; C04B 24/26; C04B 28/04; C04B 28/08; C04B 40/00; C04B 40/02; C04B 111/00; C04B 111/10

(52) U.S. Cl. CPC C04B 14/42; C04B 7/02; C04B 7/147; C04B 14/06; C04B 14/30; C04B 20/0048; C04B 22/002; C04B 24/2647; C04B 28/04; C04B 28/082; C04B 40/0046; C04B 40/0071; C04B 40/024; C04B 2111/00008; C04B 2111/1006

(57) ABSTRACT

A composition for producing a glass fiber reinforced cement rebar, the composition comprising glass fiber; and a binder, the binder impregnates the glass fibers to hold the glass fibers together, where the binder comprises a cementitious component and a non-cement component, where the non-cement component comprises graphene oxide.

### TECHNICAL FIELD

Disclosed are compositions and methods for reinforcing composite bars. Specifically, disclosed are compositions and methods for glass fiber reinforced cement rebars with fire and heat resistance properties.

### BACKGROUND

Cement-based composites are the most important and widely used building and construction materials. However, their inherent quasi-brittle behavior has limited their structural applications due to the associated crack propagation and poor tensile strength. Researchers have employed the use of cement composites with a wide variation of reinforcements, such as steel bars, steel fibers, carbon fibers, glass fibers, and polymer fibers. However, the traditional reinforcements are either in the macro-scale or micro-scale; they can enhance the crack resistance in the macro or micro scale, but they fail to stop the initiation and propagation of nano-cracks. Therefore, this creates a need to use a material with nano-size dimension as the reinforcing agent for cement-based materials.

Reinforcing concrete with rebar is essential to provide tensile strength that concrete lacks. Since concrete is porous and allows water to ingress in or through, steel reinforcement bars corrode and lead to concrete structures deterioration and failure. To address the steel rebar corrosion problem, epoxy coating was introduced. However, the coating gets chipped and scratched during the building process and pouring concrete causing localized pitting corrosion at accelerated rate due to the small areas that are exposed. This led the industry to think of other types of reinforcing materials that do not corrode and do not need thin coating or painting. Glass fiber reinforced polymer (GFRP) rebars were introduced and started to be used in various construction applications. One of the downsides of GFRP is the fire resistance of the polymer binder that holds the glass fiber bundles together to form the solid composite reinforcing bars. This polymer can be polyester, vinyl ester or epoxy. Most polyesters have a glass transition temperature of less than 100° C. while the glass transition temperature of vinyl ester and epoxy resins may have a range up to between 120° C. and 150° C., depending on the grade of resin used. The glass transition temperature of the polymer refers to the temperature at which the resin softens and loses integrity. At and above the glass transition temperature, the glass fiber, and subsequently the rebar as a whole, becomes loose inside the concrete body with zero traction with the concrete. In the case of fire, the structure reinforced with GFRP may lose integrity very early in the life of the fire and lead to a structural failure and building collapse.

### SUMMARY

Disclosed are compositions and methods for reinforcing composite bars. Specifically, disclosed are compositions and methods for glass fiber reinforced cement rebars with fire retardant and heat resistance properties.

In a first aspect, a composition for producing a glass fiber reinforced cement rebar is provided. The composition includes glass fibers and a binder, the binder impregnates the glass fibers to hold the glass fibers together. The binder includes a cementitious component and a non-cement component, where the non-cement component includes graphene oxide.

In certain aspects, the glass fibers are selected from the group consisting of alumino-borosilicate glass (E-glass), zirconia-silicate glass, and S-glass. In certain aspects, the cementitious component includes ground granulated blast-furnace slag, nano fumed silica, Type I Portland cement, and combinations of the same. In certain aspects, the ground granulated blast-furnace slag is present in an amount between 60% by weight and 65% by weight of the cementitious component. In certain aspects, the nano fumed silica is present in an amount between 8% by weight and 10% by weight of the cementitious component. In certain aspects, the nano fumed silica is selected from the group consisting of grade 98 and grade 99. In certain aspects, the Type I Portland cement is present in an amount between 25% by weight and 32% by weight of the cementitious component. In certain aspects, the non-cement component also includes polycarboxylate ether, water, dune sand, and combinations of the same. In certain aspects, the graphene oxide is present in an amount between 0.03% by weight and 0.05% by weight of the cementitious component. In certain aspects, the polycarboxylate ether is present in an amount between 1.5% by weight and 3% by weight of the cementitious component. In certain aspects, the water is present in an amount between 0.3% by weight and 0.4% by weight of the cementitious component. In certain aspects, the ratio of the cementitious component to the dune sand is 1:3. In certain aspects, the binder is in the absence of polyester. In certain aspects, the binder is in the absence of vinyl ester. In certain aspects, the binder is in the absence of epoxy.

In a second aspect, a method of producing a glass fiber reinforced cement rebar is provided. The method includes the steps of mixing a binder, the binder includes a cementitious component and a non-cement component. The cementitious component includes ground granulated blast-furnace slag, nano fumed silica, and Type I Portland cement and the non-cement component includes graphene oxide, polycarboxylate ether, water, and dune sand. The method further includes the steps of contacting glass fibers with the binder, impregnating glass fibers with the binder to produce a green bar (uncured impregnated fibers), and curing the green bar in a curing area to produce the glass fiber reinforced cement rebar.

In certain aspects, the step of impregnating the glass fibers with the binder is selected from pultrusion and compression molding. In certain aspects, the step of contacting the glass fibers with the binder, is selected from the group of pulling glass fibers through a binder mix, coating wet glass fibers with dry binder mix, and pulling glass fibers into an open mold cavity filled with binder mix. In certain aspects, the curing area is equipped with steam such that the glass fiber reinforced cement rebar is produced by steam curing the green bar.

### BRIEF DESCRIPTION OF THE DRAWINGS

These and other features, aspects, and advantages of the scope will become better understood with regard to the following descriptions, claims, and accompanying drawings. It is to be noted, however, that the drawings illustrate only several embodiments and are therefore not to be considered limiting of the scope as it can admit to other equally effective embodiments.

FIG. 1 is a graphic representation of the glass fiber reinforced cement rebar.

FIG. 2 is an embodiment of a method for producing the glass fiber reinforced cement rebar.

FIG. 3 is an embodiment of a method for producing the glass fiber reinforced cement rebar.

FIG. 4 is an embodiment of a method for producing the glass fiber reinforced cement rebar.

In the accompanying Figures, similar components or features, or both, may have a similar reference label.

### DETAILED DESCRIPTION

While the scope of the apparatus and method will be described with several embodiments, it is understood that one of ordinary skill in the relevant art will appreciate that many examples, variations and alterations to the apparatus and methods described here are within the scope and spirit of the embodiments.

Accordingly, the embodiments described are set forth without any loss of generality, and without imposing limitations, on the embodiments. Those of skill in the art understand that the scope includes all possible combinations and uses of particular features described in the specification.

The composition and methods provide a reinforced composite bar made of compacted glass fiber roving strands and a flexible (ductile) cement mix. Advantageously, the glass fiber reinforced cement rebar can resist fire compared to polymer-based rebar. Glass fiber reinforced cement rebar maintains integrity until temperatures reach between 500° C. and 600° C. Concrete also begins to lose integrity at temperatures between 500° C. and 600° C., thus advantageously, the glass fiber reinforced cement rebar exhibits the same temperature integrity as the concrete itself. Advantageously, the uncured binder is sticky mix before curing and a ductile, flexible and water impermeable solid after curing.

Advantageously, glass fiber reinforced cement rebar exhibits similar strength, similar stiffness, corrosion resistance, and similar deformability to that of glass fiber reinforced polymer rebar. The glass fiber would have the same volume fraction in the glass fiber reinforced cement as the glass fiber reinforced polymer. The glass fiber reinforced cement rebar exhibits better fire resistance compared to the glass fiber reinforced polymer rebar. The glass fiber reinforced cement rebar will maintain integrity so long as the concrete itself maintains its integrity. In contrast, glass fiber reinforced polymer exposed to fire or even elevated temperature due to fire in the vicinity will be damaged when the temperature reaches the glass transition temperature of the polymer. Rebars of glass fiber reinforced polymer will become loose inside the concrete structure as a result of the resin softening and will not provide the needed reinforcement. The glass fiber reinforced cement rebar will be more flexible and less brittle than glass fiber reinforced polymer. Glass fiber reinforced polymer rebar is made using a thermosetting resin which is brittle when cured. Advantageously, the graphene oxide and polycarboxylate ether in the glass fiber reinforced cement impart flexibility.

As used throughout, “nano fumed silica” refers to an amorphous, nano-scale, powdered silicon oxide. Fumed silica is not the same as silica fume. Fumed silica does not have alkali content, such as sodium, unlike silica fume.

As used throughout, “graphene oxide” refers to a two-dimensional nanoparticle with dimensions between 1 nm and 100 nm, an elastic modulus of about 1100 GPa and a tensile strength of about 125 GPa due to its two dimensional conjugation, as well as strong electrical conductivity, thermal conductivity of about 3000 Wm-1 K−1, and a surface area of about 2600 m² g−1. Graphene oxide is readily available via exfoliation from a low-cost source (natural graphite flakes). Graphene oxide is highly distributed in solution and interacts effectively with cement hydration products because of the oxygen-containing functional groups on its surface. Graphene oxide has a role in nano-reinforcing and nano-filling effects, crack-arresting agent, and nuclei for cement hydration within the hydration matrix. Graphene oxide can increase the performance of the resulting cement grout by creating a strong covalent bond with hydration results like calcium silicate hydrate gels.

As used throughout, “polycarboxylate ethers” refers to are comb-shaped polymers with an anionic backbone and several nonionic pendant chains, which typically are comprised of polyethylene glycols.

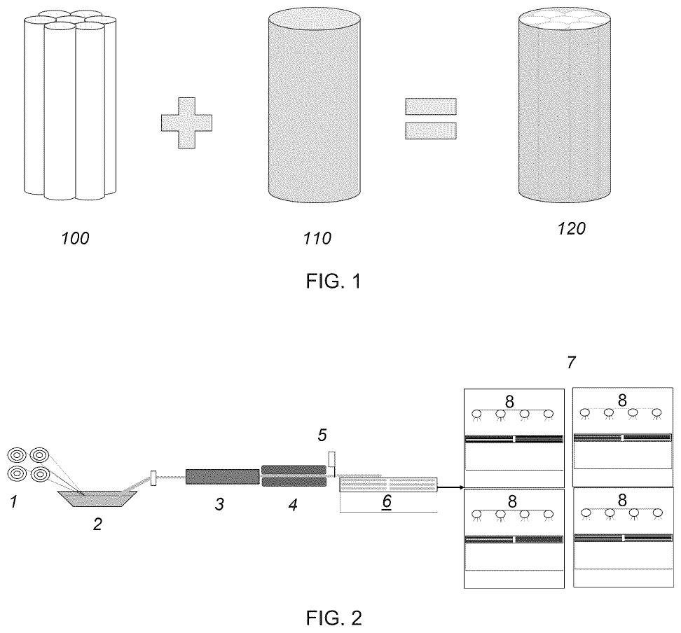

The glass fiber reinforced cement rebar composition includes glass fiber and a binder. Glass fiber 100 can be impregnated with binder 110 to produce glass fiber reinforced cement rebar 120 as shown in FIG. 1. The glass fiber can be any type of glass capable of being extruded into small diameter fibers. Examples of glass include alumino-borosilicate glass (E-glass), zirconia-silica glass, and S-glass. In at least one embodiment, the glass fibers are E-glass.

The binder can include a cementitious component and a non-cement component. The binder holds bundles of the glass fiber together.

The cementitious component can include ground granulated blast-furnace slag, nano fumed silica, and Type I Portland cement. The cementitious component is a non-alkali cement mix. Advantageously, the use of non-alkali cementitious component does not weaken the glass fibers.

Ground granulated blast-furnace slag is a by-product of iron manufacturing. When added to concrete ground granulated blast-furnace slag improves its properties such as workability, strength, and durability. Ground granulated blast-furnace slag improves concrete resistance to elevated temperatures. Ground granulated blast-furnace slag produces a sticky, slimy paste. The ground granulated blast-furnace slag can be present in an amount between 60 and 65% by weight of the cementitious component.

The nano fumed silica contributes silicon oxide that provides excess silicone to engage and react with the elements in the cementitious component that would otherwise attack the silicone of the glass fiber. The presence of the nano fumed silica reduces the weakening and damaging of the glass fiber that would occur in the absence of the nano fumed silica. Advantageously, the nano fumed silica minimizes the influence of alkali cement on the sizing of the glass fiber. Advantageously, the use of nano fumed silica enables the use of E-glass that would be degraded by the alkali environment in the absence of the nano fumed silica. The nano fumed silica also minimizes porosity of the rebar cement and can product a concrete that when reacted with ground granulated blast-furnace slag produces high early strength. The nano fumed silica can be grade 98 or grade 99. The nano fumed silica can be present in an amount between 8 and 10% by weight of the cementitious component.

The type I Portland cement can act as an activator. When producing concrete with ground granulated blast-furnace slag, Portland cement acts as a catalyst, facilitating the chemical reactions that create a strong matrix between aggregates and supplementary cementitious materials like ground granulated blast-furnace slag. It helps in forming the gel-like substance called calcium silicate hydrate (C—S—H) which contributes to the concrete strength and durability. In addition, Portland cement helps control the setting time and workability of the concrete mixture. The binder can be in the absence of other chemical activators. The type I Portland cement can be present in an amount between 25 and 32% by weight of the cementitious component.

The non-cement component can include graphene oxide, polycarboxylate ether, water, and sand.

The graphene oxide can be present between 0.03 and 0.05% by weight of the cementitious component. A binder made with graphene oxide in an amount between 0.03 and 0.05% by weight of the cementitious component delivers the best development in compressive, flexural, and split tensile strength after 28 days of curing. A graphene oxide-based concrete exhibits improved mechanical and durability properties compared to concrete in the absence of graphene oxide, Improved mechanical and durability properties include compressive strength, flexural strength, tensile strength, modulus of elasticity, abrasion resistance, capillary sorptivity, and chloride ion concentration. An amount of graphene oxide greater than 0.05% could not be properly diffused in the cementitious component because of the enrichment of calcium, which would result in a significant reduction in compressive strength. Mixing graphene oxide with the cementitious component can result in a binder with high performance due to the graphene oxide forming bonds with other admixtures in the binder. However, it is difficult to disperse graphene oxide in alkaline cement matrix due to the electrostatic interactions between the negatively charged graphene oxide layers and Ca²⁺, K⁺, Na⁺OH-ions in cement pore solution. So, either chemical modification or the use of surfactant is needed to achieve uniformly dispersed graphene oxide nanosheets in alkaline cement matrix. Concerns are raised regarding the inevitable side-effects of these modification agents or surfactants. For instance, they can retard cement hydration, entrap substantial air or improve the viscosity of cement paste. The positive effects of graphene oxide may be impaired due to the side-effects of modification agents or surfactants. Therefore, there is a trade-off between the positive effects of graphene oxide with high dosage and the negative influences of modification agents or surfactants. Maintaining an amount of graphene oxide between 0.03 and 0.05% by weight of the cementitious component results in being able to effectively disperse the graphene oxide in the cementitious component to maximize the impact on mechanical and durability properties of the resulting concrete.

The polycarboxylate ether is a super plasticizer. Polycarboxylate ethers can have a high specific surface area. Polycarboxylate ethers have been widely utilized to reinforce cement composites which improve mechanical strength on account of nucleus effects and filling effects. Polycarboxylate ethers are a type of water-reducing admixture used in concrete to improve workability and reduce water content while maintaining desired properties like strength and durability. Moreover, polycarboxylate ethers with pozzolanic activity can consume calcium hydroxide to form stable calcium silicate hydrate gels. These advantages of polycarboxylate ethers provide the motivation to hybridize with graphene oxide nanosheets for further enhancement in mechanical properties of cement composite. The polycarboxylate ether can be present in an amount between 1.5 and 3% by weight of the cementitious component. Polycarboxylate ether can be added in a liquid form. The polycarboxylate ether and fumed silica can improve the dispersion of the graphene oxide without forming graphene oxide agglomerates.

The water can be present in an amount of between 0.3 and 0.4% by weight of the cementitious component. Any type of water that complies with ASTM C1602 can be used.

The sand can be any type of fine-grained textured sand. In at least one embodiment, the sand is dune sand. Dune sand, also known as desert sand, is a type of sand found in desert regions, typically near coastal areas or in arid regions where wind processes accumulate sand dunes. Dune sand is characterized by its fine-grained texture and light color. The ratio of the cementitious component to the sand can be 1:3.

The binder when mixed is a sticky fluid before being cured. After curing, the binder forms a ductile, flexible cured solid cement product.

Any method of making the glass fiber reinforced cement can be used that impregnates the glass fibers with the binder. Examples of methods for making glass fiber reinforced cement rebar include pultrusion with steam curing, compression molding process with wet cement tank, and compression molding process with dry cement tank.

One method for making glass fiber reinforced cement can be understood with reference to FIG. 2. Referring to FIG. 2, the glass fibers can be pulled from fiber spool 1 into cement pool 2. Cement pool 2 can contain the binder mix which contains the cementitious component and non-cement component in a fluid phase. The glass fibers are pulled into and through the binder mix where they are impregnated with the binder mix and pulled through die 3 by pulling system 4. The impregnated fibers can be through cutting system 5 to the required length. The cut impregnated fibers can be laid down stretched straight on collecting tray 6. As collecting tray 6 fills with uncured impregnated fibers (called green bar) the full tray is moved to curing area 7. Each curing area 7 can be equipped with steam 8 to steam cure the uncured impregnated fibers to produce the glass fiber reinforced cement rebar.

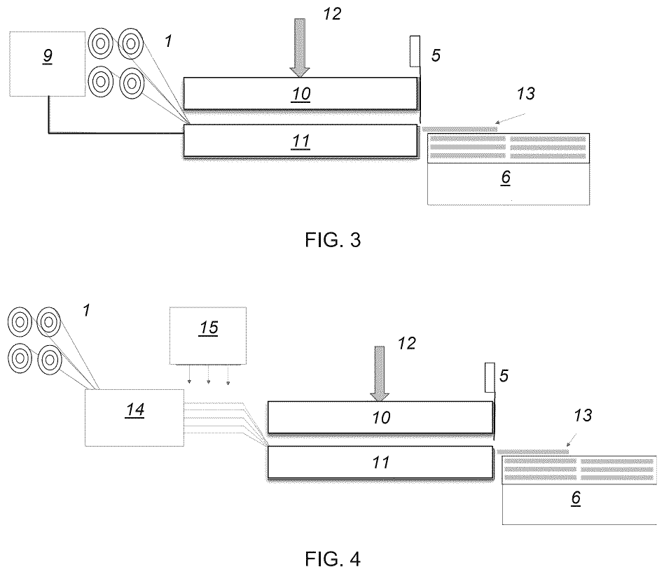

Other methods include compression molding processes to impregnate the fiber with the cement mix. Compression molding can be understood with reference to FIGS. 3 and 4. Compression molding processes use open mold cavity 11 filled with glass fibers and the binder mix. Open mold cavity 11 is the desired shape and thickness dimension of the final glass fiber reinforced cement rebar. A compressive force 12 is applied through top plate 10 to produce the glass fiber reinforced cement. The glass fiber reinforced cement can be cut to size through cutting 5 to produce glass fiber reinforced cement rebar 13 after curing on collection tray 6. The methods differ in the way the glass fibers and binder mix are introduced to open mold cavity 11. Curing can include steam curing. Advantageously, steam curing can reduce curing periods resulting in faster production of the glass fiber reinforced cement rebar 13.

In a compression molding process described with reference to FIG. 3, open mold cavity 11 is first filled with the required amount of binder mix from wet cement tank 9. Glass fibers from fiber spool 1 are pulled into open mold cavity 11 and immersed in the binder mix. Compressive force 12 is then applied through top plate 10 to produce impregnation of the glass fiber with the cement.

In a compression molding process described with reference to FIG. 4, glass fibers from fiber spool 1 run through deionized water tank 14, wetting the fibers with deionized water. Dry binder mix, in the absence of the water component, is then applied to the wet glass fibers from dry cement mix tank 15, before the coated glass fibers are fed into open mold cavity 11 and the process proceeds as described.

The glass fiber reinforced cement rebar is in the absence of polymers, including polyester, vinyl ester, vinal, and epoxy.

### Example

An example of preparing the binder is provided. The cementitious component included 270 kg ground granulated blast-furnace slag, 36 kg nano fumed silica, and 144 kg type I Portland cement. The non-cement component included 0.23 kg graphene oxide, 9 liters polycarboxylate ether, 158 liters water, and 1350 kg dune sand. The binder had the composition in Table 1.

TABLE 1
Composition of Binder

| | Weight | | Percent Amount |
|---|---|---|---|
| Component | Amount | | of Cementitious Component |
| Cementitious Component | 450 | kg | 100% |
| Ground granulated | 270 | kg | 60% |
| blast-furnace slag | | | |
| Nano fumed silica | 36 | kg | 8% |
| Type I Portland cement | 144 | kg | 32% |
| Non-cement Component | | | |
| Graphene oxide | 0.225 | kg | 0.05% |
| Polycarboxylate ether | 9 | liters | 2% |
| Water | 158 | liters | 0.35% |
| Dune sand | 1350 | kg | — |

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

There various elements described can be used in combination with all other elements described here unless otherwise indicated.

The singular forms “a”, “an” and “the” include plural referents, unless the context clearly dictates otherwise.

Optional or optionally means that the subsequently described event or circumstances may or may not occur. The description includes instances where the event or circumstance occurs and instances where it does not occur.

Ranges may be expressed here as from about one particular value to about another particular value and are inclusive unless otherwise indicated. When such a range is expressed, it is to be understood that another embodiment is from the one particular value to the other particular value, along with all combinations within said range.

Throughout this application, where patents or publications are referenced, the disclosures of these references in their entireties are intended to be incorporated by reference into this application, in order to more fully describe the state of the art to which the invention pertains, except when these references contradict the statements made here.

As used here and in the appended claims, the words “comprise,” “has,” and “include” and all grammatical variations thereof are each intended to have an open, non-limiting meaning that does not exclude additional elements or steps.

That which is claimed is:

What is claimed is:

1. A composition for producing a glass fiber reinforced cement rebar, the composition comprising:
glass fibers; and
a binder, the binder impregnates the glass fibers to hold the glass fibers together, where the binder comprises:
a cementitious component and a non-cement component, where the non-cement component comprises graphene oxide.

2. The composition of claim 1, where the glass fiber is selected from the group consisting of alumino-borosilicate glass (E-glass), zirconia-silicate glass, and S-glass.

3. The composition of claim 1, where the cementitious component comprises ground granulated blast-furnace slag, nano fumed silica, Type I Portland cement, and combinations of the same.

4. The composition of claim 3, where the ground granulated blast-furnace slag is present in an amount between 60% by weight and 65% by weight of the cementitious component.

5. The composition of claim 3, where the nano fumed silica is present in an amount between 8% by weight and 10% by weight of the cementitious component.

6. The composition of claim 3, where the nano fumed silica is selected from the group consisting of grade 98 and grade 99.

7. The composition of claim 3, where the Type I Portland cement is present in an amount between 25% by weight and 32% by weight of the cementitious component.

8. The composition of claim 1, where the non-cement component further comprises polycarboxylate ether, water, sand, and combinations of the same.

9. The composition of claim 1, where the graphene oxide is present in an amount between 0.03% by weight and 0.05% by weight of the cementitious component.

10. The composition of claim 8, where the polycarboxylate ether is present in an amount between 1.5% by weight and 3% by weight of the cementitious component.

11. The composition of claim 8, where the water is present in an amount between 0.3% by weight and 0.4% by weight of the cementitious component.

12. The composition of claim 8, where the ratio of the cementitious component to the dune sand is 1:3.

13. The composition of claim 1, where the binder is in the absence of polyester.

14. The composition of claim 1, where the binder is in the absence of vinyl ester.

15. The composition of claim 1, where the binder is in the absence of epoxy.

16. A method of producing a glass fiber reinforced cement rebar, the method comprising the steps of:
mixing a binder, the binder comprising a cementitious component and a non-cement component,
where the cementitious component comprises ground granulated blast-furnace slag, nano fumed silica, and Type I Portland cement,
where the non-cement component comprises graphene oxide, polycarboxylate ether, water, and sand;
contacting glass fibers with the binder;
impregnating glass fibers with the binder to produce a green bar; and
curing the green bar in a curing area to produce the glass fiber reinforced cement rebar.

17. The method of claim 16, where the step of impregnating the glass fibers with the binder is selected from pultrusion and compression molding.

18. The method of claim 16, where the step of contacting the glass fibers with the binder, is selected from the group of pulling glass fibers through a binder mix, coating wet glass fibers with dry binder mix, and pulling glass fibers into an open mold cavity filled with binder mix.

19. The method of claim 16, where the curing area is equipped with steam, where the glass fiber reinforced cement rebar is produced by steam curing the green bar.

20. The method of claim 16, where the glass fibers are selected from the group consisting of alumino-borosilicate glass (E-glass), zirconia-silicate glass, and S-glass.
